(19) United States
(12) Patent Application Publication
(10) Pub. No.: US 2007/0109977 A1
(43) Pub. Date: May 17, 2007

(54) Method and apparatus for improving listener differentiation of talkers during a conference call

(76) Inventors: Udar Mittal, Hoffman Estates, IL (US); James P. Ashley, Naperville, IL (US)

Correspondence Address: MOTOROLA, INC., 1303 EAST ALGONQUIN ROAD, IL01/3RD, SCHAUMBURG, IL, 60196, US

(21) Appl. No.: 11/273,670

(22) Filed: Nov. 14, 2005

(51) Int. Cl. H04L 12/16

(52) U.S. Cl. 370/260

(57) ABSTRACT

A method and apparatus for improving listener differentiation of talkers during a conference call is provided herein. Particularly, during a teleconference a node (101) will extend the bandwidth of received signals (e.g., speech). Each caller within the conference call will then have their voice projected by the node (101) to a particular spot in three-dimensional space.

### FIELD OF THE INVENTION

The present invention relates generally to communication systems and in particular, to a method and apparatus for improving listener differentiation of talkers during a conference call.

### BACKGROUND OF THE INVENTION

Teleconferencing plays a very important role for business discussion as well as personal meetings. Teleconferencing not only saves money but also saves unnecessary travel time. Even though teleconferencing has been widely used and has become more or less a necessity, the teleconferencing experience is still far from that of a physical-presence conference. In a typical teleconference, a person is talking either on a phone or a PC (using only a typical voice communication bandwidth) to a set of people at various geographical locations. In many situations, a listener is not able to recognize the talker just from his voice. In such situations, a talker has to identify himself before actually starting to speak. It would be beneficial if a listener could more easily identify individuals during a teleconference. Therefore, a need exists for a method and apparatus for improving listener differentiation of talkers during a conference call.

### BRIEF DESCRIPTION OF THE DRAWINGS

FIG. 1 is a block diagram of a communication system.

FIG. 2 shows a plot of HRTFs vs. frequency for right and left ear at various azimuth angles and when the listener is at a distance of 15 cm and 100 cm from the source.

FIG. 3 shows the ITF magnitude vs. frequency plot for various source locations.

FIG. 4 is a flow chart showing operation of a node.

### DETAILED DESCRIPTION OF THE DRAWINGS

In order to address the above-mentioned need, method and apparatus for improving listener differentiation of talkers during a conference call is provided herein. Particularly, during a teleconference a node will extend the bandwidth of received signals (e.g., speech). Each caller within the conference call will then have their voice projected by the listening device to a particular spot in three-dimensional space.

Because each talker on the conference call will have their voice projected to a particular spot in three-dimensional space, spatial separation between users is achieved. This allows the listener to more-easily identify talkers during the teleconference. Additionally, because spatial projection is taking place on bandwidth-extended speech, the listener can more-easily perceive the spatial separation between talkers.

The present invention encompasses a method for improving listener differentiation of talkers during a conference call. The method comprises the steps of receiving an input signal' extending the bandwidth of the input signal to produce a bandwidth-extended signal, determining a direction to assign the input signal, and projecting the bandwidth-extended signal in the direction.

The present invention additionally encompasses a method for improving listener differentiation of talkers during a conference call. The method comprises the steps of receiving a voice signal, extending the bandwidth of the voice to produce a bandwidth-extended voice signal, determining a direction to assign the bandwidth-extended voice signal, and projecting the bandwidth-extended voice signal in the direction using a head related impulse response (HRIR).

The present invention additionally encompasses an apparatus comprising bandwidth extension circuitry receiving an input signal and outputting a bandwidth-extended signal, direction assignment circuitry determining a direction to assign the input signal, and projection circuitry receiving the direction and the bandwidth-extended signal and outputting the bandwidth-extended signal projected in the direction.

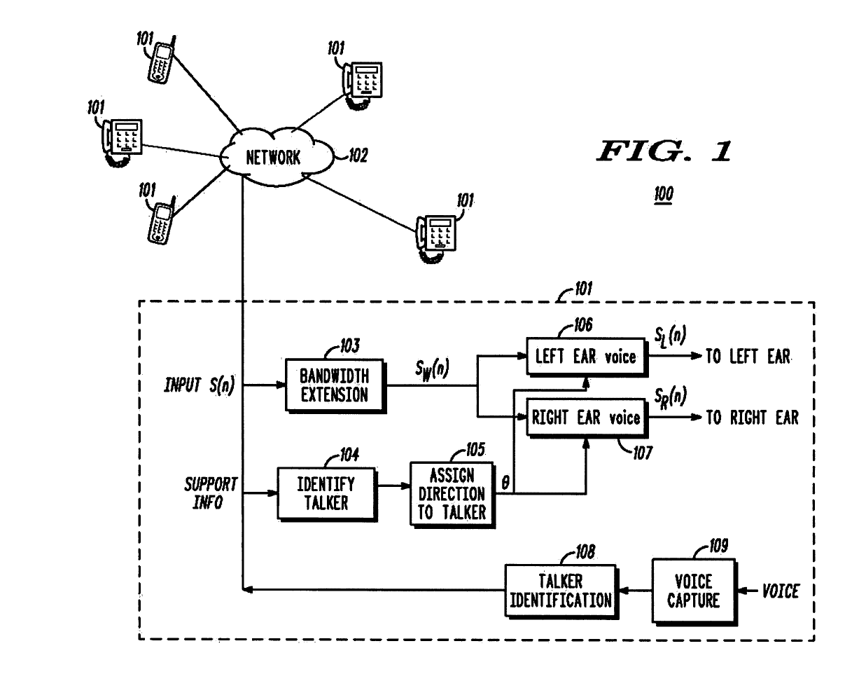

Turning now to the drawings, wherein like numerals designate like components, FIG. 1 is a block diagram of communication system 100. As shown, communication system 100 comprises a plurality of nodes 101 that serve as both voice capture devices and voice listening (projecting) devices. Nodes 101 may comprise a telephone or stereo phone or, alternatively, may be as complex as a teleconferencing system with video, audio, and data communications. Nodes 101 are configured to capture voices from one or more talkers, and transmit the voices as voice information over network 102 to other nodes 101. Nodes 101 are additionally configured to provide talker identification information that is utilized by other nodes to identify each talker. Various forms of talker identification information are possible. For example, users may be identified by their Internet Protocol (IP) or Media Access (MAC) address, or alternatively may be identified by techniques described in U.S. Pat. No. 6,882,971 METHOD AND APPARATUS FOR IMPROVING LISTENER DIFFERENTIATION OF TALKERS DURING A CONFERENCE CALL, which is incorporated by reference herein. Such techniques include using tonal or timbre characteristics of voices along with spectral correlation techniques to establish an identity of a talker.

Network 102 is configured to be any type of network that can convey voice communication between nodes 101. The term “network” over which the voice communication is established may include a voice over Internet Protocol (VoIP) system, a plain old telephony system (POTS), a digital telephone system, a wired or wireless consumer residence or commercial plant network, a wireless local, national, or international network; or any known type of network used to transmit voice, telephone, data, and/or teleconferencing information.

In addition to voice, network 102 also conveys talker identification information that identifies a particular talker. Such talker identification information can be conveyed over a main band or side band of the network. Additionally, the talker identifier system and the voice signal can be carried over different paths in the same network, or over different networks. Conveying talker identification information by nodes 101 allows for the identity of a current talker to be transmitted to a listener located proximate a node.

During operation, talker identification circuitry 104 determines an identity of a talker and passes the identity to direction assignment circuitry 105. Direction assignment circuitry 105 determines a three-dimensional (or alternatively, a two-dimensional) location (θ) for the talker and passes this information on to voice projection circuitry 106 and 107. Voice projection circuitry 106 produces voice that is heard by a listener's left ear, while voice projection circuitry 107 produces voice that is heard by a listener's right ear.

Voice projection circuitry 106 and 107 preferably comprises a binaural headphone where stereophonic speech can be projected. Thus, speech coming from a talker can now be made to appear as if it is coming from a certain direction. (Speech appearing to come from certain direction is referred to as projecting the speech). Once the speech from different talkers is projected in different directions, a listener may be able to identify the talker from the projected direction.

Stereophonic sounds can be generated from the monaural speech by transforming it using head related impulse response (HRIR), h(t). HRIR is the impulse response which determines the sound pressure that an arbitrary source produces at the ear drum. The Fourier transform H(ƒ) of HRIR is called the Head Related Transfer Function (HRTF). Once the HRTF for the left ear and the right ear are known, a binaural signal can be synthesized from a monaural source. For example, the U.S. patent application Ser. No. 10/945789 (US20050069140 A1) METHOD AND DEVICE FOR REPRODUCING A BINAURAL OUTPUT SIGNAL GENERATED FROM A MONAURAL INPUT SIGNAL, which is incorporated by reference herein, provides a method for generating a binaural output signal from a monaural input signal for VoIP applications.

The projecting of speech may improve the teleconferencing experience when the monaural input speech is wideband (0-8 KHz). However, when the input speech is narrowband (0-4 KHz), these methods are not robust enough to properly project speech from different talkers to different directions, and hence are not able to provide an improved teleconferencing experience. This deficiency is because of certain properties of HRTF.

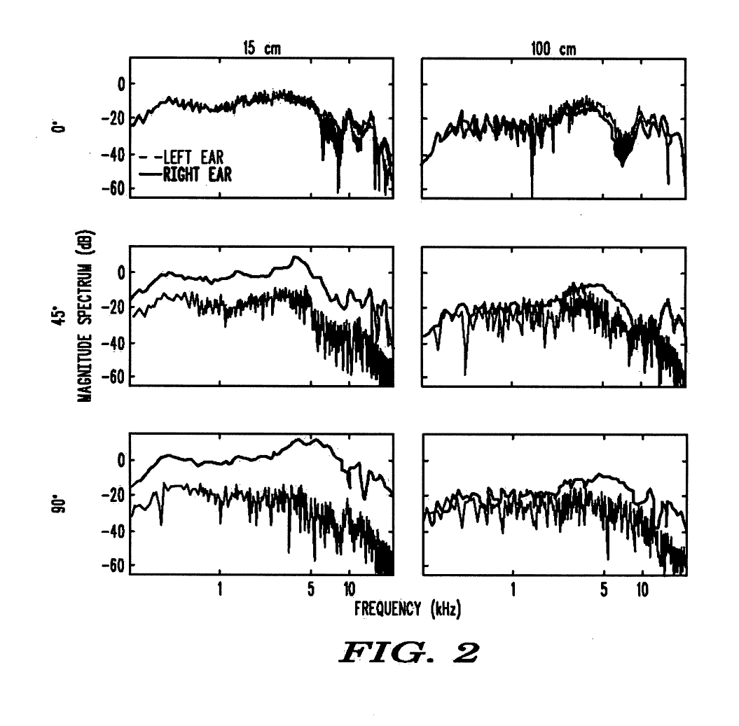

To understand why transforming the narrowband speech through HRTFs may not produce desired directionality effect, we need to look at the properties of HRTFs in the frequency domain. A plot of HRTFs vs. frequency for right and left ear at various azimuth angles and when the listener is at a distance of 15 cm and 100 cm from the source is shown in FIG. 2. The plot is taken from B. G. Shinn-Cunningham, J. G. Desloge, N. Kopco, “Empirical and modeled acoustic transfer functions in a simple room: effect of distance and direction,” IEEE Workshop on Applications of Signal Processing to Audio and Acoustic, 2001, and has be reproduced here as FIG. 2.

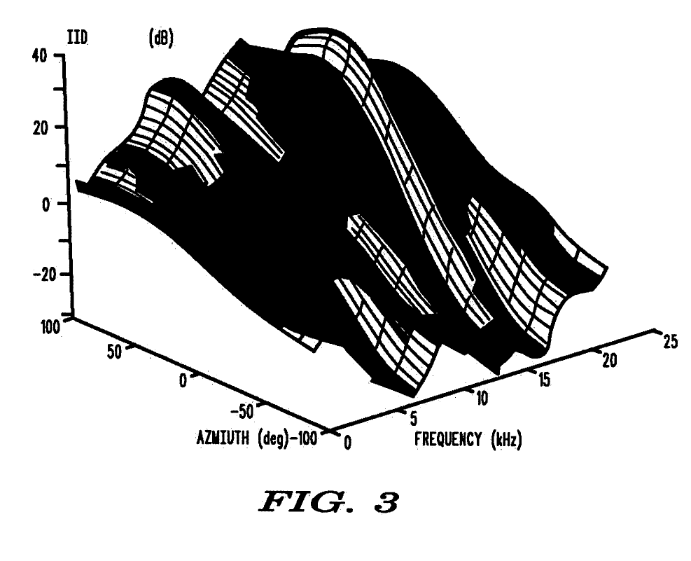

It can be seen from FIG. 2 that when the source is at 100 cm distance then the main difference between the right and left ear HRTFs is in the frequency region of 4 KHz to 6 KHz. To measure the difference between the right and left ear HRTFs, the ratio of the right and left ear HRTF has been defined as interaural transfer function (ITF). Let H_{R}(ƒ) and H_{L}(ƒ) be the HRTFs for right and left ear, respectively. The ITF H_{I}(ƒ)=H_{R}(ƒ)/H_{I}(ƒ). FIG. 3 (taken from R. O. Duda, “Modeling head related transfer functions,” IEEE 1993, pp. 996-1000) shows the magnitude ITF vs. frequency plot for various source locations. FIG. 3 also suggests that in the narrowband range (0-4 KHz), the magnitude ITF is close to 0 dB, i.e., there is no significant difference between the right and left ear HRTFs in the narrow band range. Thus, if a narrowband speech is passed through left and right ear HRTFs and the output is played directly on left and right earphone, respectively, then there will not be any significant difference between the two outputs. Hence, just applying HRTFs to the narrowband speech may not be able to help the listener by projecting the speech from different talkers in different directions.

In order to address this issue, bandwidth extension circuitry 103 is provided to extend the bandwidth of the speech signal s(n). Bandwidth extension circuitry uses various techniques (typically non-linear) to transform a narrowband speech to a wideband speech (preferably, 0-8 kHz). It has been shown that the bandwidth expanded speech is more pleasant to the ear than the corresponding narrowband speech. Moreover, the bandwidth extended speech is also more intelligible and allows for spatial projection of the received speech.

Optionally, θ may be provided to bandwidth extension circuitry 103 to extend that part of the bandwidth which may be more important for HRTFs of the given direction (θ). Thus, the bandwidth is extended based on the direction. More particularly, if for an assigned azimuth (θ), the magnitude of the ITF around a certain frequency(F) is relatively higher than it is around other frequencies then bandwidth extension method may generate a bandwidth extended signal having more energy around frequency(F)

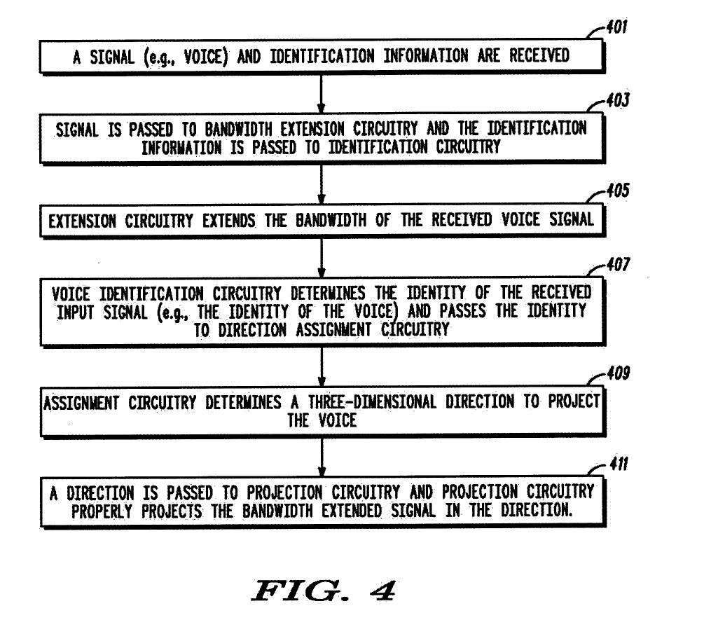

FIG. 4 is a flow chart showing operation of node 100. In particular, FIG. 4 shows those steps necessary to properly bandwidth extend and project received voice during a conference call. During a conference call, all nodes 100 capture a user's voice via voice capture circuitry 109. The voice is identified via voice identification circuitry 108, and the voice and identification information is passed to other nodes 101 in the conference call.

At step 401 a signal (e.g., voice) and identification information are received by node 101. The signal is passed to bandwidth extension circuitry 103 and the identification information is passed to identification circuitry 104 (step 403). At step 405 bandwidth extension circuitry extends the bandwidth of the received voice signal to produce a bandwidth-extended signal, and passes the bandwidth-extended signal to projection circuitry 106 and 107. Bandwidth extension takes place by finding an estimate of the high band part (4 KHz to 8 KHz) from the low band part (0 KHz to 4 KHz) and then combining the low band part and the estimate of the high band part to generate wideband speech signal from the narrowband speech signal.

At step 407 voice identification circuitry 104 determines the identity of the received input signal (e.g., the identity of the voice) and passes the identity to direction assignment circuitry 105. At step 409 assignment circuitry determines a three-dimensional direction to project the voice. A particular direction may be determined randomly or the listener may assign the directions to the talkers according to his preference or liking. For example, the listener may determine the direction so that he may have least ambiguity in identifying the important talkers from their apparent directions. The direction assignment can also be changed during the teleconferencing session.

At step 411 a direction is passed to projection circuitry 106 and 107 and projection circuitry 106 and 107 properly projects the bandwidth extended signal in the direction. Particularly, stereophonic sounds are generated by circuitry 106 and 107 from the monaural speech by transforming it using head related impulse response (HRIR).

While the invention has been particularly shown and described with reference to a particular embodiment, it will be understood by those skilled in the art that various changes in form and details may be made therein without departing from the spirit and scope of the invention. For example, while the above techniques were described with a conference call transmitting voice communication, one of ordinary skill in the art will recognize that other sounds may be transmitted. Such sounds include, but are not limited to an artificially or organically intelligent agent or humanoid assisted with a voice synthesis program. Additionally, the term “voice” as used in this disclosure intends to apply to the human voice, sound production by machines, music, audio, or any other similar voice or sound. It is intended that such changes come within the scope of the following claims.

1. A method for improving listener differentiation of talkers during a conference call, the method comprising the steps of:
receiving an input signal;
extending the bandwidth of the input signal to produce a bandwidth-extended signal;
determining a direction to assign the input signal; and
projecting the bandwidth-extended signal in the direction.

2. The method of claim 1 wherein the step of determining the direction comprises the step of determining a three dimensional direction.

3. The method of claim 1 wherein the step of receiving an input signal comprises the step of receiving a voice signal.

4. The method of claim 3 wherein the step of determining the direction of the input signal comprises the step of determining the direction of the input signal based on an identity of the voice signal.

5. The method of claim 1 wherein the step of determining the direction of the input signal comprises the step of determining the direction of the input signal based on an identity of the input signal.

6. The method of claim 1 wherein the step of extending the bandwidth of the input signal to produce a bandwidth-extended signal comprises the step of extending the bandwidth to 0-8 kHz.

7. The method of claim 1 wherein the step of projecting the bandwidth-extended signal comprises the step of projecting the bandwidth-extended signal using a head related impulse response (HRIR).

8. The method of claim 1 wherein the step of extending the bandwidth comprises the step of extending a part of the bandwidth that is more important for HRTFs.

9. The method of claim 1 wherein the step of extending the bandwidth comprises the step of extending the bandwidth based on the direction.

10. A method for improving listener differentiation of talkers during a conference call, the method comprising the steps of:
receiving a voice signal;
extending the bandwidth of the voice to produce a bandwidth-extended voice signal;
determining a direction to assign the bandwidth-extended voice signal; and
projecting the bandwidth-extended voice signal in the direction using a head related impulse response (HRIR).

11. The method of claim 10 wherein the step of determining the direction comprises the step of determining a three dimensional direction.

12. The method of claim 10 wherein the step of determining the direction of the input signal comprises the step of determining the direction of the input signal based on an identity of the voice signal.

13. The method of claim 10 wherein the step of extending the bandwidth of the voice signal to produce a bandwidth-extended voice signal comprises the step of extending the bandwidth to 0-8 kHz.

14. An apparatus comprising:
bandwidth extension circuitry (103) receiving an input signal and outputting a bandwidth-extended signal;
direction assignment circuitry (105) determining a direction to assign the input signal; and
projection circuitry (106, 107) receiving the direction and the bandwidth-extended signal and outputting the bandwidth-extended signal projected in the direction.

15. The apparatus of claim 15 wherein the direction comprises a three dimensional direction.

16. The apparatus of claim 15 wherein the input signal comprises a voice signal.

17. The apparatus of claim 15 wherein the bandwidth-extended signal is 0-8 kHz.

18. The apparatus of claim 15 wherein the projection circuitry utilizes a head related impulse response (HRIR) to project the signal.

19. The apparatus of claim 15 wherein bandwidth extension circuitry extends a part of the bandwidth based on the direction.
